(19) United States
(12) Patent Application Publication
(10) Pub. No.: US 2006/0189713 A1
(43) Pub. Date: Aug. 24, 2006

(54) Aqueous pigment preparations for brilliant ink jet prints

(75) Inventors: Udo Herrmann, Dormagen (DE); Dirk Pfuetzenreuter, Burscheid (DE); Hans-Jurgen Hartrumpf, Leverkusen (DE); Josef Witt, Leverkusen (DE); Daniela Gesekus, Julich (DE); Gudrun-Margot Goldau, Koln (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/352,548

(22) Filed: Feb. 13, 2006

(30) Foreign Application Priority Data
Feb. 19, 2005 (DE) 10 2005 007 763.3

(51) Int. Cl. C03C 17/00

(52) U.S. Cl. 523/160

(57) ABSTRACT

Aqueous pigment preparations comprising a) at least one pigment
b) at least one polymeric carboxylic acid comprising interpolymerized alkoxylated or nonalkoxylated alpha-hydroxy-C₁-C₆-alkyl-acrylic acid units and at least one component c) and/or d), of which c) is a surfactant which is nonionic and/or anionic, and d) is a condensation product based on A) sulphonated aromatics B) aldehydes and/or ketones and if appropriate C) one or more compounds selected from the group of nonsulphonated aromatics, urea and urea derivatives.

The invention concerns aqueous pigment preparations, processes for their production and their use, in particular for producing recording fluids for ink jet printing.

Aqueous printing inks for ink jet printing are well known not only on the basis of water-soluble organic dyes but also on the basis of organic colour pigments. Pigments provide the prints with a significantly higher light and ozone stability than dyes. However, the dispersion properties of pigment inks militate in some cases against a wide use of pigment inks. Particles may agglomerate in a non-optimal dispersion, so that the particle size distribution changes. The colour strength of the prints decreases, start-of-print problems can arise.

What is more, non-optimal dispersant systems may build structures in the aqueous phase which hinder undisrupted flow of the ink into the capillaries of the printing head.

Another approach is to functionalize the pigments (U.S. Pat. No. 5,554,739 and U.S. Pat. No. 5,922,118). However, the disadvantage is the increased tendency to migrate and the associated lower water fastness. And the functionalized types of pigment are not even completely immune to sedimenting by the dispersions.

The invention then has for its object to provide pigment preparations having little tendency to agglomerate, especially having good start-of-print performance, which provide brilliant prints. Further, the stability of the dispersions to the wetting agents and solvents customarily used in the inks should be good, so that potential users experience little if any restriction in their choice of ink constituents.

This object is achieved by aqueous pigment preparations comprising
a) at least one pigment
b) at least one polymeric carboxylic acid comprising interpolymerized alkoxylated or nonalkoxylated alpha-hydroxy-C₁-C₆-alkyl-acrylic acid units and at least one component c) and/or d),
   of which
c) is a surfactant which is nonionic and/or anionic, and
d) is a condensation product based on
   A) sulphonated aromatics
   B) aldehydes and/or ketones and if appropriate
   C) one or more compounds selected from the group of nonsulphonated aromatics, urea and urea derivatives.

Useful pigments include not only inorganic pigments but also organic pigments.

Organic pigments herein comprehend vat dyes as well. It will be appreciated that the pigment preparations of the present invention may also comprise mixtures of various organic or inorganic pigments or organic and inorganic pigments. The average particle size of the pigments is preferably less than 220 nm and in particular less than 180 nm.

Examples of suitable pigments (a) include:

Organic Pigments:

Monoazo Pigments:

C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;

Disazo Pigments:

C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188,

Anthanthrone Pigments:

C.I. Pigment Red 168; (C.I. Vat Orange 3);

Anthraquinone Pigments:

C.I. Pigment Yellow 147 and 177; C.I. Pigment Violet 31;

Anthrapyrimidine Pigments:

C.I. Pigment Yellow 108; (C.I. Vat Yellow 20);

Quinacridone Pigments:

C.I. Pigment Red 122, 202 and 206; C.I. Pigment Violet 19;

Quinophthalone Pigments:

C.I. Pigment Yellow 138;

Dioxazine Pigments:

C.I. Pigment Violet 23 and 37,

Diketopyrrolopyrrole Pigments

C.I. Pigment Orange 71; C.I. Pigment Red 255; C.I. Pigment Red 254

Flavanthrone Pigments:

C.I. Pigment Yellow 24; (C.I. Vat Yellow 1);

Indanthrone Pigments:

C.I. Pigment Blue 60; (C.I. Vat Blue 4) and 64 (C.I. Vat Blue 6);

Isoindoline Pigments:

C.I. Pigment Orange 69; C.I. Pigment Red 260; C.I. Pigment Yellow 139 and 185;

Isoindolinone Pigments:

C.I. Pigment Orange 61; C.I. Pigment Red 257 and 260; C.I. Pigment Yellow 109, 110, 173 and 185;

Isoviolanthrone Pigments:

C.I. Pigment Violet 31; (C.I. Vat Violet 1);

Metal Complex Pigments:

C.I. Pigment Yellow 117, 150 and 153; C.I. Pigment Green 8;

Perinone Pigments:

C.I. Pigment Orange 43; (C.I. Vat Orange 7); C.I. Pigment Red 194; (C.I. Vat 15);

Perylene Pigments:

C.I. Pigment Black 31 and 32; C.I. Pigment Red 123, 149, 178, 179, (C.I. Vat Red 23), 190 and 240; C.I. Pigment Violet 29;

Phthalocyanine Pigments:

C.I. Pigment Blue 15, 15:1, 15:2, 15:3, 15:4, 15:6 and 16; C.I. Pigment Green 7 and 36;

Pyranthrone Pigments:

C.I. Pigment Orange 51; C.I. Pigment Red 216; (C.I. Vat Orange 4);

Thioindigo Pigments:

C.I. Pigment Red 88 and 181; (C.I. Vat Red 1); C.I. Pigment Violet 38; (C.I. Vat Violet 3);

Triarylcarbonium Pigments:

C.I. Pigment Blue 1, 61 and 62; C.I. Pigment Green 1; C.I. Pigment Red 81, 81:1 and 169; —C.I. Pigment Black 1 (aniline black); —C.I. Pigment Yellow 101 (aldazine yellow); —C.I. Pigment Brown 22.

Vat Dyes (Apart from Those Already Mentioned Above):

C.I. Vat Yellow 2, 3, 4, 5, 9, 10, 12, 22, 26, 33, 37, 46, 48, 49 and 50;

C.I. Vat Orange 1, 2, 5, 9, 11, 13, 15, 19, 26, 29, 30 and 31;

C.I. Vat Red 2, 10, 12, 13, 14, 16, 19, 21, 31, 32, 37, 41, 51, 52 and 61;

C.I. Vat Violet 2, 9, 13, 14, 15, 17 and 21;

C.I. Vat Blue 1 (C.I. Pigment Blue 66), 3, 5, 10, 12, 13, 14, 16, 17, 18, 19, 20, 22, 25, 26, 29, 30, 31, 35, 41, 42, 43, 64, 65, 66, 72 and 74;

C.I. Vat Green 1, 2, 3, 5, 7, 8, 9, 13, 14, 17, 26, 29, 30, 31, 32, 33, 40, 42, 43, 44 and 49;

C.I. Vat Green 1, 2, 3, 5, 7, 8, 9, 13, 14, 17, 26, 29, 30, 31, 32, 33, 40, 42, 43, 44 and 49;

C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 83 and 84,

C.I. Vat Black 1, 2, 7, 8, 9, 13, 14, 16, 19, 20, 22, 25, 27, 28, 29, 30, 31, 32, 34, 36, 56, 57, 58, 63, 64 and 65;

Inorganic Pigments:

White Pigments:

Titanium dioxide (C.I. Pigment White 6), zinc white, pigment grade zinc oxide; zinc sulphide, lithopone;

Carbon Blacks

Interference Pigments:

metal effect pigments based on coated metal platelets; pearl lustre pigments based on metal-oxide-coated mica platelets; liquid crystal pigments.

Preferred pigments in this context are monoazo pigments (especially laked BONS pigments, Naphtol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, pyrrolopyrrole pigments, triarylcarbonium pigments (alkali blue pigments, laked rhodamines, dye salts with complex anions), isoindoline pigments and carbon blacks (especially gas or furnace blacks).

Examples of particularly preferred pigments are specifically: C.I. Pigment Yellow 138, Pigment Yellow 74, Pigment Yellow 150, C.I. Pigment Red 122, C.I. Pigment Red 254, C.I. Pigment Violet 19, C.I. Pigment Blue 15:3 and 15:4, C.I. Pigment Black 7, C.I. Pigment Orange 5, 38 and 43 and C.I. Pigment Green 7, C.I. Pigment Green 36.

Particularly preferred pigments are those of the carbon black type, such as Spezialschwarz®4, Spezialschwarz®4a, Spezialschwarz®100, Spezialschwarz®250, Spezialschwarz®350 and Spezialschwarz®550 from Degussa, and also pigment grade carbon blacks of the types FW 200, FW 2, FW 2V, FW 285, FW 1, FW 18, S 160, S 170 from Degussa and also Printex types from Degussa.

It was found that, surprisingly, the pigment preparations of the present invention have distinctly better properties than those having just the copolymer described under b).

As the grinding time of aqueous preparations comprising just the copolymer b) increases, the colour strength and the filterability do increase, but the amount of ink actually printed decreases substantially. This effect is also time dependent, so that stable printing behaviour cannot be ensured. Moreover, such dispersions were found to gel after a short time in storage.

Preferably, the concurrent use of component b) with at least one of components c) and/or d) yields dispersions which do not provide an age-dependent printed amount of ink and, what is more, remained liquid after storage at 50° C.

In a preferred embodiment, the alkoxylated and nonalkoxylated copolymer of component b) possesses alpha-hydroxyethylacrylic acid units optionally alkoxylated with ethylene oxide, propylene oxide and/or butylene oxide, in particular with ethylene oxide. The copolymer of component b) preferably has an acid number of 40-100%, preferably 55-80%, an alkoxy, in particular ethoxy, fraction of 10-35% preferably of 10% to 25% by weight, based on component b), and an OH number of preferably 200-600 and in particular of 350480 mg of KOH/g of substance. The molar mass is 500-3000 g/mol, preferably 1000-2500 g/mol.

The methods of determination for the abovementioned parameters are to be found for example in:

DGF Einheitsmethoden ISBN 3-8047-1297-5 and also in Wissenschaftliche Verlagsgesellschaft Stuttgart 1994.

(Meth)acrylic acid is a preferable possibility as a further, preferred building block component for the comonomers of component b). The ratio of (meth)acrylic acid to alpha-hydroxy-C₁-C₆-alkylacrylic acid is preferably in the range from 4:1 to 2:1.

Other unsaturated alcohols having 6-12 carbon atoms are useful for example as a further building block component.

It is preferable to alkoxylate, in particular ethoxylate and/or propoxylate, the hydroxyalkyl group of copolymer b) following the polymerization.

The surface tension of the component b) copolymer used is preferably more than 40×10⁻³ nm, in particular more than 45×10⁻³ nm.

Surfactant component c) may comprise not only emulsifiers which are nonionic and anionic in one molecule, preferably ethoxylates of alcohols, carboxylic acids, amines and fatty acid glycerides having a chain length of respectively 8-18 carbon atoms, whose cloud point is preferably above 80° C. and which have preferably been sulphated, carboxylated or phosphated, as well as mixtures of sulphonated/sulphated and ethoxylated surfactants.

Especially alkyl radicals having 6-18 carbon atoms and also alkylbenzene radicals having 4-16 carbon atoms in the chain are useful for the anionic components.

The nonionic component c) is preferably an ethoxylate of alcohols, amines or carboxylic acids having a chain length of 8-18 carbon atoms that preferably has a cloud point above 80° C.

The surface tension of the component c) surfactant used is preferably less than 39×10⁻³ N/m.

Preferred surfactants for component c) are for example alkoxylated polydimethylsiloxanes such as for example Tegopren®3110 or Tegopren®5442, sulphosuccinic esters such as for example Aerosol®OT and also alkoxylated alkynediols such as for example Surfinol®465.

Preferred surfactants further include alkoxylated alcohols such as for example phenol+2.8 mol of styrene+29 mol of EO carboxylated and oleyl alcohol+30 mol of EO.

“Based on” denotes that the condensation product d) may have been prepared from further reactants as well as A, B and optionally C. Preferably, however, the condensation products herein are prepared only from A, B and optionally C.

Sulphonated aromatics of component A) herein include sulphomethylated aromatics. Preferred sulphonated aromatics are: naphthalenesulphonic acids, phenolsulphonic acids, dihydroxybenzenesulphonic acids, sulphonated ditolyl ethers, sulphomethylated 4,4′-dihydroxydiphenylsulphone, sulphonated diphenylmethane, sulphonated biphenyl, sulphonated hydroxybiphenyl, especially 2-hydroxybiphenyl, sulphonated terphenyl or benzenesulphonic acids.

Useful aldehydes and/or ketones of component B) include especially aliphatic, cycloaliphatic and also aromatic ones. Preference is given to aliphatic aldehydes, particular preference being given to formaldehyde and also other aliphatic aldehydes having 3 to 5 carbon atoms.

Useful nonsulphonated aromatics for component C) include for example phenol, cresol, 4,4′-dihydroxydiphenyl sulphone or dihydroxydiphenylmethane.

Useful urea derivatives include for example dimethylurea, melamine or guanidine.

The preferred condensation product used for component dl) is one based on
A) at least one sulphonated aromatic selected from the group of naphthalenesulphonic acids, phenolsulphonic acids, dihydroxybenzenesulphonic acids, sulphonated ditolyl ethers, sulphomethylated 4,4′-dihydroxydiphenyl sulphone, sulphonated diphenylmethane, sulphonated biphenyl, sulphonated hydroxybiphenyl, in particular 2-hydroxybiphenyl, sulphonated terphenyl and benzenesulphonic acids,
B) formaldehyde and if appropriate
C) one or more compounds selected from the group of phenol, cresol, 4,4′-dihydroxydiphenyl sulphone, dihydroxydiphenylmethane, urea, dimethylolurea, melamine and guanidine.

The condensation product preferably obtained in the course of the condensation has an average degree of condensation which is preferably in the range from 1 to 150, more preferably in the range from 1 to 20 and especially in the range from 1 to 5.

The condensation products of component d) can be used as an aqueous solution or suspension or as a solid for example as a powder or granulate, preferably as a spray-dried powder or granulate.

Preferred condensation products of component d) have an inorganic salt content of below 10% by weight, preferably below 5% by weight and especially below 1% by weight, based on the aqueous solution or suspension of the component used or based on the solid of component d) used.

It is likewise preferable to use condensation products of component d) which are low in residual monomer or free from residual monomer.

By “low in monomer” is meant a residual monomer content of less than 30% by weight, preferably less than 20% by weight, based on the condensation product, especially <10% by weight, preferably <5% by weight. Residual monomers in this connection are the reactants used for preparing the condensation product.

Such condensation products which are low in salt and low in residual monomer are known for example from EP-A 816 406.

The condensation products of component d) can be prepared for example by first preparing the sulphonated aromatics of component A) if appropriate in a mixture with nonsulphonated aromatics of component C) by reacting the underlying aromatics with a sulphonating agent preferably sulphuric acid, in particular concentrated sulphuric acid, chlorosulphonic acid, amidosulphonic acid or oleum.

The amount of sulphonating agent used per 1 mol of the aromatic underlying the component A) is preferably in the range from 0.4 to 3.2 mol and in particular in the range from 0.8 to 1.6 mol of sulphonating agent.

This is followed by the condensation with aldehydes and/or ketones of component B), preferably formaldehyde, if appropriate together with further compounds of component C). The condensation is preferably carried out in aqueous solution at a pH in the range from 0 to 9. From 0.4 to 1.5 mol, in particular from 0.4 to 1.0 mol of component B) is preferably used per mole of the sulphonated aromatic A) or per mole of a mixture of sulphonated aromatics of component A) and nonsulphonated aromatics of component C).

This is followed if appropriate by neutralizing the sulphonated condensation product of component d) with a base.

The component b) is preferably used in an amount of 5-200% by weight and in particular 5-80%, based on the weight of pigment a).

The two components c) and d) are together used in an amount which is preferably in the range of 1-80% and in particular of 540%, based on pigment a).

Preferred aqueous pigment preparations comprise
0.2% to 50% and preferably 1% to 35% by weight of at least one pigment of component a)
altogether 5% to 40% by weight of components b), c) and d), and
1% to 88% and preferably 5-60% by weight of aqueous medium.

Aqueous medium is either water alone or a mixture of water with organic solvents which preferably have a water solubility of more than 5 g/l at 20° C.

The aqueous medium is preferably more than 60% by weight, more preferably more than 65% by weight and in particular more than 80% by weight water.

Useful organic solvents include:

Aliphatic C₁-C₄ alcohols, linear or branched, aliphatic ketones such as acetone, methyl ethyl ketone, diacetone alcohol, polyols such as 1,5-pentanediol, trimethylolpropane, ethylene glycol, diethylene glycol, triethylene glycol, polyglycols having a molar mass of 200-2000 g/mol, propylene glycol, dipropylene glycol, tripropylene glycol, glycerol and thiodiglycol, and 1,2,6-hexanetriol, 2-pyrrolidone, N-methylpyrrolidone, N-ethylpyrrolidone, 1,3-dimethylimidazolidinone, dimethylacetamide and also dimethylformamide.

Mixtures of the solvents mentioned may also be used.

The invention further provides a process for producing the pigment preparation according to the invention, characterized in that components a) to d), where used, are homogenized together with water, then if necessary freed of coarse particles preferably by means of a 1-10 μm membrane, a glass filter or paper cloth and the pigment preparation is optionally dried.

The homogenizing is preferably effected by beating the individual components in a dissolver and then grinding in a high energy bead mill using zirconium oxide beads for example.

The preparation is then generally filtered, for example through 1-10 μm membrane or glass fibre filters.

The pigment preparations according to the invention exhibit excellent storage stability and provide prints of excellent lightfastness not only on thermal bubble jet (HP, Encad) but also on piezo printers (Epson, Mutoh). In addition, they have the following advantages:

No clogging of print head and also high water and migration fastness.

Good stability on the part of the dispersion to solvents such as 1,2-propanediol, 2,2′-thiodiethanol, glycerol, diethylene glycol, triethylene glycol, 2-pyrrolidone, 1,5-pentanediol, isopropanol, dipropylene glycol, tripropylene glycol, 1,2,6-hexanetriol and wetting agents such as Tegopren®3110, Tegopren®5442 (both alkoxylated polydimethylsiloxanes), Aerosol®OT (sulphosuccinic ester), Surfinol®465 (alkoxylated alkynediols).

Tegopren® is a product of Degussa, Aerosol®OT is a product of Cyanamid, Surfinol®465 is a product of Air products.

The fundamentals of colour measurement may be found in:

Farbmessung BAYER Farben Revue, Sonderheft 3/2D (1986).

The aqueous pigment preparations according to the invention are very useful for printing sheetlike or three-dimensionally configured substrates by the ink jet process, which is characterized in that the ink jet inks are printed onto the substrate and the print obtained is then fixed if desired.

The ink jet process is usually carried out with aqueous inks, which are sprayed as small droplets directly onto the substrate. There is a continuous form of the process, in which the ink is pressed at uniform rate through a nozzle and the jet is directed onto the substrate by an electric field depending on the pattern to be printed, and there is an interrupted ink jet (for example, according to the drop-on-demand process), in which the ink is expelled only where a coloured dot is to appear, the latter form of the process employing either a piezoelectric crystal or a heated hollow needle (bubble or thermal jet process) to exert pressure on the ink system and so eject an ink droplet from the nozzle. These techniques are described in Text Chem. Color, Band 19 (8), pages 23 to 29, 1987, and volume 21 (6), pages 27 to 32.

The ink jet inks according to the invention are particularly useful for the bubble jet process and for the printing process employing a piezoelectric crystal.

When the print is to be fixed, it is possible to proceed in a known manner and as described in WO-A-99/01516 and, for example, for a binder, if desired in the form of a dispersion or emulsion, to be applied atop the printed substrate and cured or for a film to be laminated onto the printed substrate.

Further details concerning these binders are to be found in WO-A-99/01516.

The aqueous pigment preparations according to the invention can be printed on all kinds of substrate materials. Examples of substrate materials include
coated or uncoated cellulosics such as paper, paperboard, cardboard, wood and woodbase,
coated or uncoated metallic materials such as foils, sheets or workpieces composed of aluminium, iron, copper, silver, gold, zinc or alloys thereof,
coated or uncoated silicatic materials such as glass, porcelain and ceramics,
polymeric materials of any kind such as polyamides, polyesters, hydrophilicized polyethylene,
hydrophilicized polypropylene, melamin resins, polyacrylates, polyacrylonitrile, polyurethanes, polycarbonates, polyvinyl chloride, polyvinyl alcohols, polyvinyl acetates, polyvinylpyrrolidones and corresponding block and nonblock copolymers, biodegradable polymers and natural polymers such as gelatin,
textile materials such as fibres, yarns, threads, knits, wovens, nonwovens and made-up product composed of polyester, modified polyester, polyester blend fabric, cellulosics such as cotton, cotton blend fabric, jute, flax, hemp and ramie, viscose, wool, silk, polyamide, polyamide blend fabric, polyacrylonitrile, triacetate, acetate, polycarbonate, polypropylene, polyvinyl chloride, polyester microfibres and glass fibre fabric,
leather—both natural and artificial—in the form of smooth leather, nappa leather or suede leather,
comestibles and cosmetics.

The aqueous recording fluids (inks) are preferably obtained by adjusting the pigment preparations obtained by the process according to the invention to the desired colour strength by addition of water and/or organic solvents.

### EXAMPLES

Base fluid for pigment ink printing tests:

15% of 1,5-pentanediol

10% of polyglycol 200

5% of 2-pyrrolidone

70% of completely ion-free water

Reference inks for the examples are the HP-UV inks for the HP 2000 printer. These are characterized as follows.

The UV inks for the HP 2000 Designjet comprise the following pigments:

| | | | |
|---|---|---|---|
| magenta: | C 1894A UV | 3% | of Pigment Red 122 |
| cyan: | C 1893A UV | 1.8% | of Pigment Blue 15:3 |
| yellow: | C 1895A UV | 1.6% | of Pigment Yellow 74 |
| black: | C 1892A UV | 5% | of carbon black |

all based on the ink.

The colour strengths in the examples were measured using a Byk-Gardner colorimeter against prints of these HP inks on the identical papers. The typical amount of ink per test page is 0.5 g for the HP UV inks.

### Comparative Example 1

### Just Copolymer of Component b

A dissolver is charged with 3.2 kg of completely ion-free water and 300 g of copolymer b) having an OH number of 460, an acid number of 76 and an ethoxy content of 22%. 1.5 kg of P.Y. 74 are gradually sprinkled in (15 minutes) before homogenizing for 30 minutes. The suspension is subsequently ground using a Drais V-15 bead mill and zirconium oxide beads (0.7-0.9 mm). Samples are taken after 45, 90 and 150 minutes, the base fluid is used to produce an ink having a pigment concentration of 1.5% and this ink is used on an HP 6122 ink jet printer (bubble jet) to print on a 90 g/m² paper, for example HP Bright white®.

| Grinding time | Amount printed | Colour strength |
|---|---|---|
| 45 minutes | 0.44 g | 160% |
| 45 minutes | 0.34 g | 120% |
| 150 minutes | 0.16 g | 40% |

As the grinding time increases, the amount of ink printed per test page decreases.

### Inventive Example 1

A dissolver is charged with 3.15 kg of completely ion free water, 200 g of copolymer from the comparative example, 50 g of a surfactant mixture (30% of aqueous solution comprising 1:1 mixture, anionic surfactant (sulphonate/sulphate) having an average chain length of 12 carbon atoms and nonionic surfactant having an average chain length of 12-14 carbon atoms and a degree of ethoxylation of 20); (\hat{=} Dispense Ayd W-22) and 2% (based on total charge) of a desalted naphthalenesulphonic acid-formaldehyde condensate (molar mass about 1100 g/mol). 1.5 kg of P.Y. 74 are gradually scattered in 15 minutes before homogenizing for 30 minutes. The suspension is subsequently ground for 4 hours using a Drais V-15 bead mill and zirconium oxide beads (0.7-0.9 mm). A sample is taken every hour. The dispersion is passed through a 10 μm filter to remove coarse fractions.

The base fluid is added to produce an ink having a pigment concentration of 1.5% by weight and this ink is printed on an HP 6122 ink jet printer onto a 90 g/m² paper (HP Bright white).

| Grinding time | Amount printed | Colour strength |
|---|---|---|
| 60 minutes | 0.45 g | 200% |
| 120 minutes | 0.48 g | 240% |
| 180 minutes | 0.5 g | 260% |
| 240 minutes | 0.51 g | 270% |

### Inventive Example 2

A dissolver is charged with 3642 g of completely ion free water, 200 g of the copolymer from the comparative example and 142.9 g of surfactant mixture of Inventive Example 1 (35% solution). 1000 g of Pigment Red 254 are sprinkled in with stirring and the dispersion is homogenized. The suspension is subsequently ground for 1.5 hours with a Drais V-15 bead mill and zirconium oxide beads (0.7-0.9 mm) and subsequently passed through a 10 μm filter to remove coarse fractions. The particle size determined by dynamic light scattering measurement at 90° (angle dimension) was 150 nm.

The base fluid is added to produce an ink having a pigment concentration of 3% by weight, which is filtered through a 5 μm filter and used to print onto HP Bright white and HP Premium paper on an HP 6122 ink jet printer.

Amount printed=0.48 g

The colour locus on HP® Bright White paper is L=57.7, a=48.6, b=19.4

The colour locus on HP® Premium paper is L=49.7, a=61, b=39

### Inventive Example 3

290.6 g of completely ion free water, 16 g of copolymer c) from Inventive Example 1, 11.4 g of 35% solution of the surfactant mixture of Inventive Example 1 and 2 g of a desalted naphthalenesulphonic acid-formaldehyde condensate (molecular weight about 1100 g/mol) are charged to a dissolver and 80 g of Pigment Orange 64 are sprinkled in.

The suspension is ground in a Süβimeier laboratory mill using 400 ml of zirconium silicate beads (0.6-0.8 mm) for 2 hours. The particle size determined by dynamic scattering light measurement at 90° was 160 nm.

The base fluid is added to produce an ink (1.5% pigment content), which is filtered through a 5 μm filter and outputted on an Epson Stylus Color 760 printer.

The colour locus on HP Premium paper is L=59, a=52, b=49.

### Inventive Example 4

1204.5 g of completely ion free water, 120 g of copolymer c) from Inventive Example 1, 85.7 g of surfactant mixture from Inventive Example 1 (35% solution) and 15 g of a desalted naphthalenesulphonic acid-formaldehyde condensate (MW=1100 g/mol) are charged to a dissolver. 1565.8 g of moist presscake of Pigment Yellow 150 (47.9% strength) are added in the course of 15 minutes. The homogeneous suspension is circulation ground in a Drais V-15 bead mill using 0.7-0.9 zirconium oxide beads for 1 hour.

The particle size was 127 nm (determined by dynamic scattered light measurement at 90° angle dimension).

The base fluid is used to produce an ink of 1.5% by weight pigment content, which is filtered through a 5 μm filter and printed up on an HP 6122 printer. The amount printed per page is 0.5 g and the colour strength on HP Bright White is 155%.

### Inventive Example 5

1773.9 g of completely ion free water, 180 g of a copolymer c) from Inventive Example 1, 257 g of surfactant mixture (from Inventive Example 1) (35%) and 30 g of a desalted naphthalenesulphonic acid-formaldehyde condensate (from Inventive Example 3) are charged to a dissolver. 700 g of Pigment Blue 15:3 are sprinkled in and the suspension is homogenized. It is circulation ground in a Drais V-15 bead mill (0.7-0.9 mm beads) for 1 hour. The particle size was 130 nm. After filtration through a 10 μm filter, the base fluid is used to produce an ink having a pigment content of 1.8% by weight, which is printed up on an HP 6122 printer. The amount of print per test page was 0.45 g. The colour strength was 180% on HP Bright White and 170% on HP Premium paper.

### Inventive Example 6

2035 g of completely ion free water, 180 g of a copolymer from Inventive Example 1, 90 g of a desalted naphthalenesulphonic-formaldehyde condensate (MW=1100 g/mol) and 85.7 g of a 35% solution of the surfactant mixture from Inventive Example 1 are charged to a dissolver. 600 g of Pigment Red 122 are sprinkled in and homogenized. This is followed by circulation grinding in a Drais V-15 bead mill (0.7-0.9 mm beads) for 3 hours. The particle size was 115 mm. After filtration through a 10 μm filter, the base fluid is used to produce an ink having a pigment content of 3% by weight, which is printed up on an HP 6122 printer. 0.48 g are printed per test page. The colour strength is 110% on HP Bright white paper.

### Inventive Example 7

186.9 g of completely ion free water, 32 g of a copolymer from Inventive Example 1, 8 g of the surfactant mixture from Inventive Example 3 and 8 g of a desalted naphthalenesulphonic-formaldehyde condensate from Inventive Example 3 are charged to a dissolver and 140 g of Pigment Green 36 are sprinkled in. After homogenization, the suspension is ground in a Süβmeier laboratory bead mill with 0.6-0.8 mm zirconium oxide beads for 4 hours. The particle size was 140 nm. The base fluid is added to produce an ink having a 1.8% pigment content. After filtration through a 5 μm filter, the ink is printed up on an HP 6122 printer. 0.38 g are printed per test page on HP Bright White paper.

### Inventive Example 8

The inks of Inventive Example 1 (yellow), Inventive Example 5 (cyan) and Inventive Example 6 (magenta) are used in an Encad Novajet® 700 large format plotter. The print is onto Euromedia Perstex B1, a water-resistant scratch-resistant film composed of polyester.

The prints are brilliant and resistant to wash solution at 30° C. without further fixation. (0.2% of decaethoxynonylphenol laundry detergent, based on total amount, fabric stirred for 30 minutes).

### Inventive Example 9

The inks of Inventive Example 2 and of Inventive Example 6 are mixed in a ratio of 1:8 to obtain a very bright magenta. The inks of Inventive Example 1 (yellow) and Inventive Example 5 (cyan) are used with the mixture in an ENCAD Novajet 700 large format plotter.

The prints onto polyester fabric are bright and resistant to rubbing off without specific fixing. A 30° C. wash does not impair the prints. (0.2% of laundry detergent, 30 minutes of stirring the fabric).

### Inventive Example 10

The pigment dispersion of Inventive Example 5 (Pigment Blue 15:3) is admixed with 10% of each solvent, stored at 65° C. for 2 days and then combined with the base fluid to produce the standard ink, and the print is compared with the original of Inventive Example 5.

| | | Amount of print per | Colour |
|---|---|---|---|
| Solvent | Consistency | test page | strength |
| 10% 1,2-Propanol | fluid | 0.44 g | 170% |
| 10% 2,2′-Thiodiethanol | fluid | 0.48 g | 180% |
| 10% Glycerol | fluid | 0.45 g | 165% |
| 10% 1,5-Pentanediol | fluid | 0.43 g | 150% |
| 10% 2-Pyrrolidone | fluid | 0.47 g | 170% |
| 10% Isopropanol | fluid | 0.42 g | 150% |
| 10% Ethanediol | fluid | 0.45 g | 160% |
| 10% Dipropylene glycol | fluid | 0.46 g | 165% |
| 10% 2-Methyl-2-propanol | fluid | 0.44 g | 160% |
| 10% Butyldiglycol | fluid | — | — |

1. Aqueous pigment preparations comprising
a) at least one pigment
b) at least one polymeric carboxylic acid comprising interpolymerized alkoxylated or nonalkoxylated alpha-hydroxy-C₁-C₆-alkyl-acrylic acid units and at least one component c) and/or d),
of which
c) is a surfactant which is nonionic and/or anionic, and
d) is a condensation product based on
A) sulphonated aromatics
B) aldehydes and/or ketones and if appropriate
C) one or more compounds selected from the group of nonsulphonated aromatics, urea and urea derivatives.

2. Pigment preparations according to claim 1 comprising said component b) in an amount of 540% by weight, based on the pigment of component a).

3. Pigment preparations according to claim 1, comprising said component c) and/or d) in an amount of altogether 5-40% by weight, based on pigment a).

4. Pigment preparations according to claim 1, wherein said component c) comprises ethoxylates of alcohols, carboxylic acids, amines and fatty acid glycerides having a chain length of respectively 8-18 carbon atoms, as well as mixtures of sulphonated/sulphated and ethoxylated surfactants.

5. Pigment preparations according to claim 1, wherein said component c) comprises ethoxylates of alcohols, carboxylic acids, amines and fatty acid glycerides having a chain length of respectively 8-18 carbon atoms, whose cloud point is above 80° C. and which have been sulphated, carboxylated or phosphated, as well as mixtures of sulphonated/sulphated and ethoxylated surfactants.

6. Pigment preparations according to claim 1, wherein said component d) comprises at least one condensation product based on
A) at least one sulphonated aromatic selected from the group of naphthalenesulphonic acids, phenolsulphonic acids, dihydroxybenzenesulphonic acids, sulphonated ditolyl ethers, sulphomethylated 4,4′-dihydroxydiphenyl sulphone, sulphonated diphenylmethane, sulphonated biphenyl, sulphonated hydroxybiphenyl, in particular 2-hydroxybiphenyl, sulphonated terphenyl and benzenesulphonic acids,
B) formaldehyde and if appropriate
C) one or more compounds selected from the group of phenol, cresol, 4,4′-dihydroxydiphenyl sulphone, dihydroxydiphenylmethane, urea, dimethylolurea, melamine and guanidine.

7. Pigment preparations according to claim 1, wherein the residual monomer content of the condensation product of said component d) comprises less than 30% by weight, based on the condensation product.

8. Pigment preparations according to claim 1, wherein said component a) comprises Pigment Red 122 and Pigment Red 254.

9. Pigment preparations according to claim 1, wherein said component a) comprises C.I. Pigment Yellow 74, C.I. Pigment Blue 15:3 or C.I. Pigment Red 122 or Pigment Red 122 and Pigment 254.

10. A process for printing sheetlike or three-dimensionally configured substrates by ink jet with and without subsequent fixing, wherein the pigment preparation according to claim 1 is used as ink.
